(19) United States
(12) Patent Application Publication
(10) Pub. No.: US 2017/0072777 A1
(43) Pub. Date: Mar. 16, 2017

(54) STRUCTURE OF END PART OF WEATHER STRIP

(71) Applicant: NISHIKAWA RUBBER CO., LTD., HIroshlma-shi (JP)

(72) Inventors: Toshimichi KAWAGUCHI, Hiroshima-shi (JP); Michihiko MATSUMOTO, Hiroshima-shi (JP)

(21) Appl. No.: 15/257,115

(22) Filed: Sep. 6, 2016

(30) Foreign Application Priority Data
Sep. 11, 2015 (JP) 2015-179740

(51) Int. Cl. B60J 10/80; E06B 7/16; E05F 15/40

(52) U.S. Cl. CPC B60J 10/80; E05F 15/40; E06B 7/16; E05Y 2900/531

(57) ABSTRACT

A structure of an end part of a weather strip is for use on a space in which a flange breaks off. The flange is on a door of an automobile. The weather strip is formed by integrally molding a hollow part with an installation base member having a U-shaped cross section. The weather strip has an insert buried therein. The insert has a convex formed thereon. The convex extends in a longitudinal direction of the weather strip. A concave of the installation base member on the end part of the weather strip formed by extrusion molding is fit on the convex, and die molding material integrally connects the end part of the weather strip formed by extrusion molding and the insert.

### CROSS REFERENCE TO RELATED APPLICATION

This application claims the benefit under 35 USC §119 of JP Patent Application JP 2015-179740 filed Sep. 11, 2015, the entire disclosure of which is incorporated herein by reference.

### BACKGROUND INFORMATION

The present invention relates to a structure of end parts of weather strips and a method of molding the end parts of the weather strips, which are operatively coupled on positions without flanges. The positions without the flanges are on upper parts or lower parts of sliding doors on wagons, minivans or sedans, which move frontward and rearward of automobile bodies.

The weather strips are fixed on flanges on automobile doors or bodies of door opening sides generally by means of reaction force from claw parts on inner sides of installation base members having U-shaped cross sections.

But, an automobile body of FIG. 10 is narrow in radius of curvature on a corner and large in a door opening. Accordingly, as shown in FIG. 9, a sliding door 100 is under restriction on designs and may include a position 110 without a flange 101 on an upper part 160 or a lower part 170 thereof.

Generally, end parts of the weather strips are die molded and fixed on the position 110 without the flange 101 by clips or double sided tapes.

But the weather strips fixed on the position 110 without the flange 101 include hollow parts in cross section formed by extrusion molding as well as the die molded parts.

There have been demands for extending the weather strips having sensors for detecting objects over wider ranges. The sensors are in the hollow parts of the weather strips for detecting arms, legs or the like while closing the sliding doors 100.

In this connection, it has been known to make cuts on folded parts of the flange 101 on which the weather strips having the sensors are operatively coupled (Japanese unexamined Patent Publication No.2005-075085, FIG. 11). But there has remained a problem that the weather strips are not stably fixed on the cuts on the folded parts of the flange 101.

Also, it has been known to use brackets on positions without the flange 101 for connecting flanges on upper sides with flanges on lower sides for reinforcement (Japanese examined Patent Publication No. 5476898, FIG. 8). But the brackets are separate from the weather strips. Accordingly, the structure does not extend the weather strips having the sensors.

Accordingly, an object of the present invention is to provide the structure of the end parts of the weather strips and the method of molding the end parts of the weather strips, which are operatively coupled on the positions without the flanges stably.

### SUMMARY

In order to achieve the above-mentioned object, according to one aspect of the invention, a structure of an end part of a weather strip (10) is provided, the weather strip (10) being operatively coupled on a space (120) in which a flange (101) breaks off, the flange (101) being on a door (100) of an automobile or on a body of a door opening side, the weather strip (10) being formed by integrally molding a hollow part (12) or a lip with an installation base member (11) having a U-shaped cross section, the weather strip (10) having an insert (20) buried therein, wherein:

the insert (20) has a convex (22) formed thereon, the convex (22) extending in a longitudinal direction of the weather strip (10), a concave (15) of the installation base member (11) on the end part of the weather strip (10) being fit on the convex (22), and die molding material (30) integrally connecting the end part of the weather strip (10) and the insert (20).

In addition, according to an aspect of the present invention, the convex (22) formed on the insert (20) includes a wide part (22A) and a narrow part (22B) in plate thickness by turns in the longitudinal direction, and the concave (15) of the installation base member (11) of the weather strip (10) is fit on the wide part (22A) and the narrow part (22B) of the convex (22).

In addition, according to an aspect of the present invention, an end part of the insert (20) at a center side of the weather strip (10) is the wide part (22A1), and the concave (15) of the installation base member (11) of the weather strip (10) is fit on the wide part (22A1).

In addition, according to an aspect of the present invention, the hollow part (12) is integrally molded with the installation base member (11), and the hollow part (12) is a hollow for inserting a sensor (130) therein, the sensor (130) outputting an electric signal when an object is disposed between the door (100) and the door opening for detecting the object.

In addition, according to an aspect of the present invention, a method of molding an end part of a weather strip (10) is provided, the weather strip (10) being operatively coupled on a space (120) in which a flange (101) breaks off, the flange (101) being on a door (100) of an automobile or on a body of a door opening side, the weather strip (10) being formed by integrally molding a hollow part (12) or a lip with an installation base member (11) having a U-shaped cross section, the weather strip (10) having an insert (20) buried therein, the method including:

forming a convex (22) on the insert (20), the convex (22) extending in a longitudinal direction of the weather strip (10); fitting a concave (15) of the installation base member (11) on the convex (22), the concave (15) of the installation base member (11) being on the end part of the weather strip (10) formed by extrusion molding; and integrally connecting the end part of the weather strip (10) formed by extrusion molding and the insert (20) by die molding.

Symbols in parentheses show constituents or items corresponding to the drawings.

According to the present invention, the end part of the weather strip having the insert buried therein is operatively coupled on the space in which the flange breaks off. The flange is on the door of the automobile or on the body of the door opening side. The structure of the end part of the weather strip is that: the concave of the installation base member of the weather strip is fit on the convex on the insert; and the die molding material integrally connects the concave of the installation base member and the convex on the insert. Accordingly, the weather strip is operatively coupled stably even on the position without the flange.

Also, the end part of the weather strip, not a separate bracket as in the prior art, is installed on the position without the flange. Accordingly, the end part of the weather strip formed by extrusion molding may be extended from a position with the flange and installed. As a result, shape and sealing pressure of the hollow part or the lip of the weather strip becomes substantially uniform. Also, the sensor inserted in the hollow part of the weather strip detects objects over a wider range.

In addition, the concave of the installation base member of the weather strip is fit on the wide part and the narrow part of the convex on the insert. That is, more die molding material flows into the concave of the installation base member with the narrow part than the concave of the installation base member with the wide part. As a result, fitting force of the concave of the installation base member is strong even at the narrow part of the convex on the insert.

Strength and weakness in the fitting force of the concave of the installation base member relative to the convex on the insert enables to operatively couple the installation base member on the insert more strongly. Also, positioning the installation base member on the insert for fitting becomes easy.

In addition, the end part of the insert at the center side of the weather strip is the wide part, and the corresponding concave of the installation base member of the weather strip is fit on the wide part. The structure prevents the die molding material for covering the insert from flowing into a non-insert existing side of the concave of the installation base member.

### BRIEF DESCRIPTION OF THE DRAWINGS

FIG. 1 is a side view showing a state that an end part of a weather strip according to an embodiment of the present invention is operatively coupled on a sliding door of FIG. 9;

FIG. 2 is an I-I line enlarged cross section of FIG. 1;

FIG. 3 is a II-II line enlarged cross section of FIG. 1;

FIG. 4 is a III-III line enlarged cross section of FIG. 1;

FIG. 5 is a perspective view of an insert for use in a structure of an end part of a weather strip according to an embodiment of the present invention;

FIG. 6 is a perspective view showing a state that a weather strip formed by extrusion molding is fit on the insert of FIG. 5;

FIG. 7 is a perspective view showing a state that die molding material unifies the insert and the weather strip of FIG. 6;

FIG. 8 is a II-II line enlarged cross section of FIG. 1, showing an end part of another weather strip according to an embodiment of the present invention;

FIG. 9 is a side view of an important part of the sliding door having a position without a flange; and

FIG. 10 is an external side view of an automobile having the sliding door.

### DETAILED DESCRIPTION

Referring to drawings, a structure of an end part of a weather strip according to an embodiment of the present invention will be described.

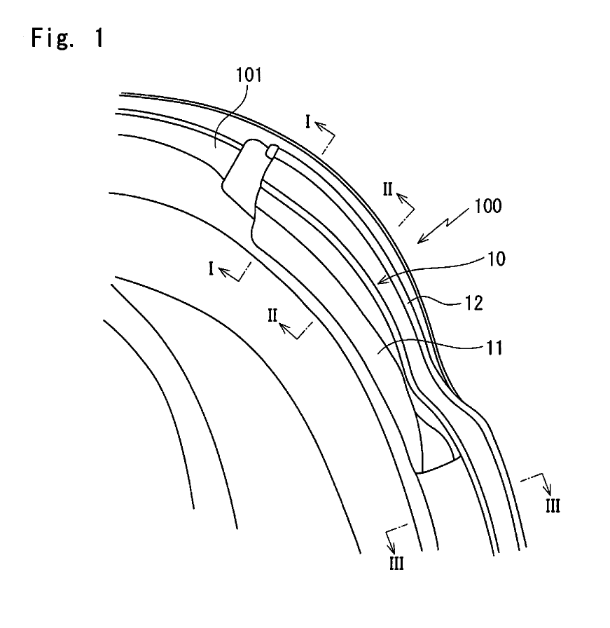

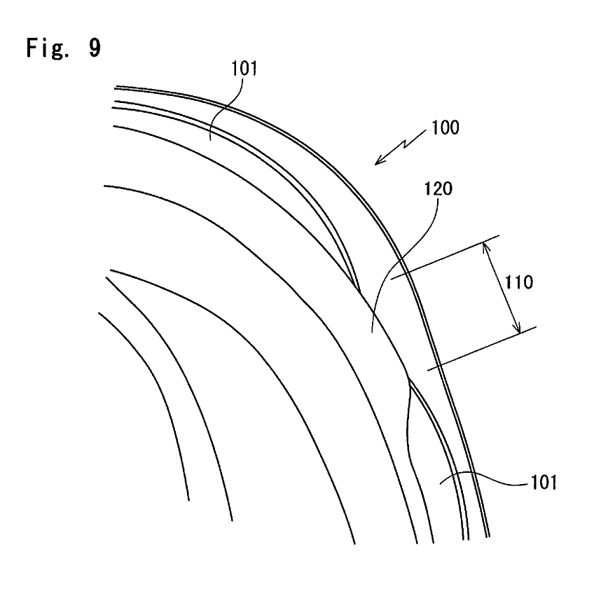

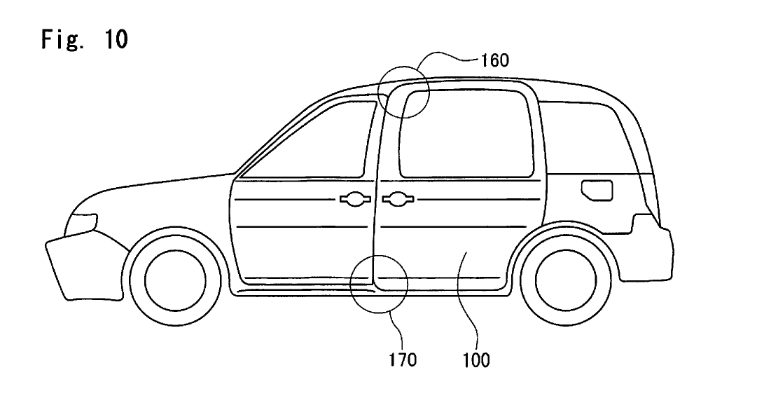

As shown in FIG. 1, FIG. 9 and FIG. 10, the structure of the end part of the weather strip according to the embodiment of the present invention is operatively coupled on a position 110 without a flange 101 on an upper part of a sliding door 100 on a wagon, a minivan or a sedan, which moves frontward and rearward of an automobile body.

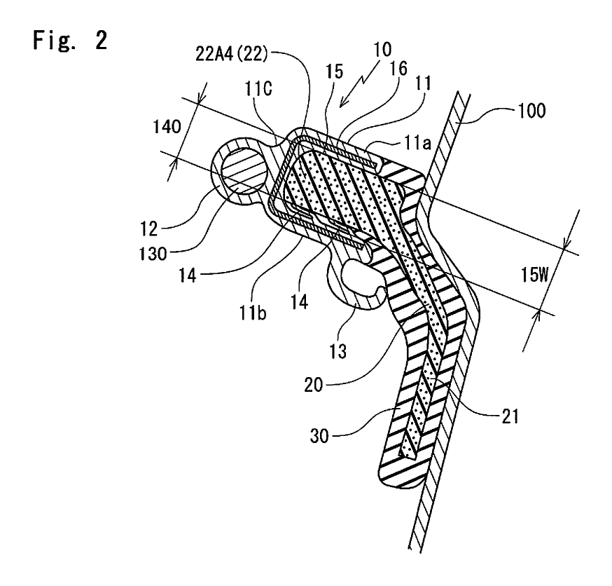

As shown in FIG. 2 to FIG. 4, a weather strip 10 includes a hollow part 12 integrally formed with an installation base member 11 having a substantially U-shaped cross section. The weather strip 10 has an insert 20 buried therein. The hollow part 12 extends in an upper and lower direction and is a hollow for inserting a sensor (pressure sensitive sensor) 130 therein. The sensor 130 in the hollow part 12 outputs a corresponding electric signal upon detecting an object such as a part of human bodies (fingers or legs) between the sliding door 100 and a door opening.

The installation base member 11 includes: a first side wall 11a, a second side wall 11b and a connecting wall 11c which connects the first side wall 11a and the second side wall 11b. When the weather strip 10 is operatively coupled on the sliding door 100, the first side wall 11a is on an outer-cabin side (front side) of the sliding door 100, the second side wall 11b is on an inner-cabin side (rear side) of the sliding door 100, and the connecting wall 11c is on the inner-cabin side. Two holding lips 14, 14 extend from an inner surface of the second side wall 11b. The installation base member 11 has a core 16 embedded therein, having a substantially U-shaped cross section.

The hollow part 12 protrudes toward the inner-cabin side from the connecting wall 11c of the installation base member 11, has a shape of a tube, and extends in the upper and lower direction. A channel part 13 having a substantially C-shaped cross section is formed on an outer surface of the second side wall 11b of the installation base member 11 for holding a wire harness (not shown) joined with the sensor 130 to be inserted later. The channel part 13 does not necessarily have the substantially C-shaped cross section as long as the channel part 13 can hold the wire harness. Also, the channel part 13 can be omitted.

The installation base member 11, the hollow part 12, the channel part 13 and the holding lip 14 form an extrusion molded part made of a rubber like elastic body including: synthetic rubber such as ethylene-propylene-diene rubber (EPDM); and thermoplastic elastomer such as TPO, TPS. The end part is die molded for arranging an external shape thereof.

In the present embodiment, the sensor 130 is inserted in the hollow part 12 later. But the sensor 130 may be integrally molded simultaneously with the hollow part 12 (see, for example, Japanese examined Patent Publication No. 3718922, FIG. 10).

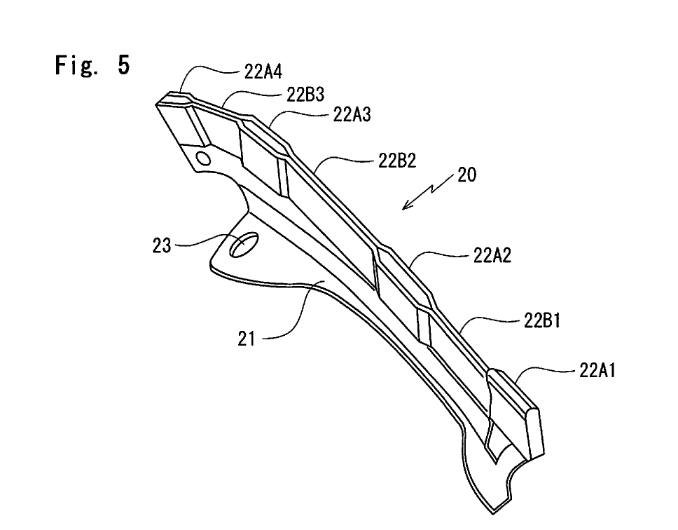

As shown in FIG. 5, the insert 20 includes: a main body 21 which extends in a longitudinal direction (upper and lower direction when operatively coupled) of the weather strip 10; and a convex 22 which extends in the longitudinal direction in the same manner as the main body 21 and protrudes toward the inner-cabin side. A concave 15 of the installation base member 11 of the weather strip 10 formed by extrusion molding is fit on the convex 22. The convex 22 is shorter than the position 110 without the flange 101. As the end part of the weather strip is operatively coupled on a space 120 in which the flange 101 breaks off, the convex 22 is arranged to extend along the flange 101. In other words, the convex 22 continuously extends behind the flange 101.

The convex 22 includes a wide part 22A and a narrow part 22B by turns in the longitudinal direction. Width of the wide part 22A and the narrow part 22B is wide and narrow respectively in a direction orthogonal to the longitudinal direction. In the present embodiment, the convex 22 includes four wide parts 22A (22A1, 22A2, 22A3, 22A4) and three narrow parts 22B (22B1, 22B2, 22B3). The wide parts 22A are positioned on both ends of the convex 22.

Width 140 of the wide part 22A is: substantially the same as internal width of the installation base member 11, which is width 15W of the concave 15; or narrower than the width 15W by thickness of the holding lips 14, 14. Since the holding lips 14, 14 protrude from the second side wall 11b of the installation base member 11, the concave 15 of the installation base member 11 is pressed onto the wide part 22A of the convex 22 on the insert 20 against large resistance. On the other hand, when the holding lips 14, 14 come into contact with the narrow part 22B, the concave 15 of the installation base member 11 is pressed onto the narrow part 22B against small resistance which is smaller than the large resistance in the wide part 22A.

Plate thickness between the narrow part 22B and the wide part 22A may be transformed by providing difference in level. In the present embodiment, the plate thickness is tapered off and gradually changed. The insert 20 may be made of metal. In the present embodiment, the insert 20 is made of resin for weight reduction and improving adherence to the die molding material 30.

A hole 23 is formed on the insert 20 for fixing the weather strip 10 on the automobile body.

The end part of the weather strip 10 is molded as follows.

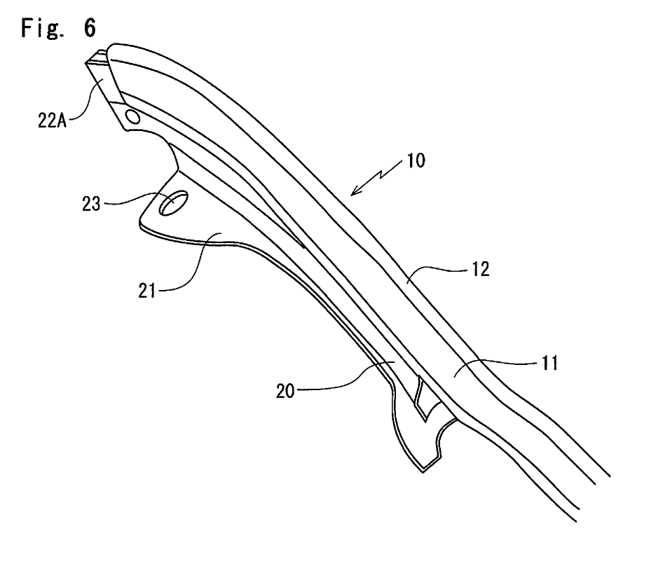

First, as shown in FIG. 6, the concave 15 of the installation base member 11 on the end part of the weather strip 10 is fit on the convex 22 formed on the insert 20.

An end surface of the convex 22 on the insert 20, which is the end surface of the wide part 22A on an uppermost position, may accord with an end surface of the end part of the weather strip 10 formed by extrusion molding. In the present embodiment, the concave 15 of the installation base member 11 of the weather strip 10 formed by extrusion molding is fit on the convex 22 formed on the insert 20 while the end surface of the convex 22 protrudes upward relative to the end surface of the end part of the weather strip 10 formed by extrusion molding.

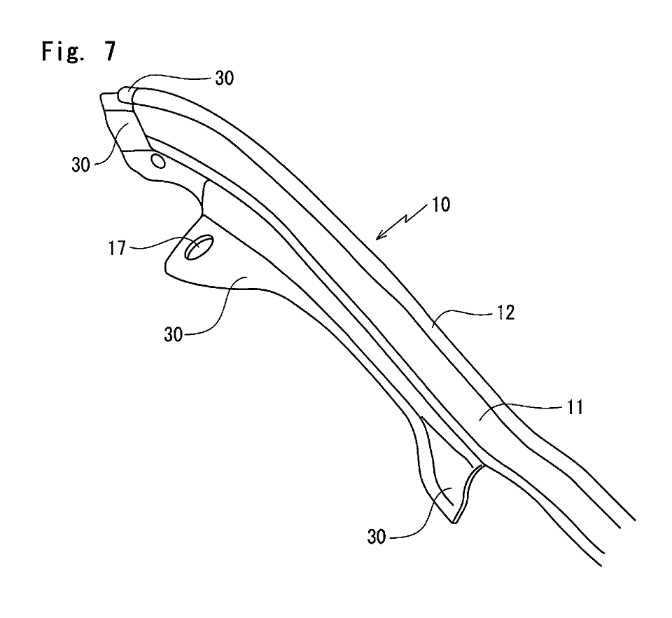

Next, the end part of the weather strip 10 formed by extrusion molding, which is fit on the convex 22 on the insert 20, is arranged on a die (not shown) and the die molding material 30 is poured into the die. As a result, as shown in FIG. 7, the insert 20 and the end part of the weather strip 10 formed by extrusion molding are integrally connected by die molding.

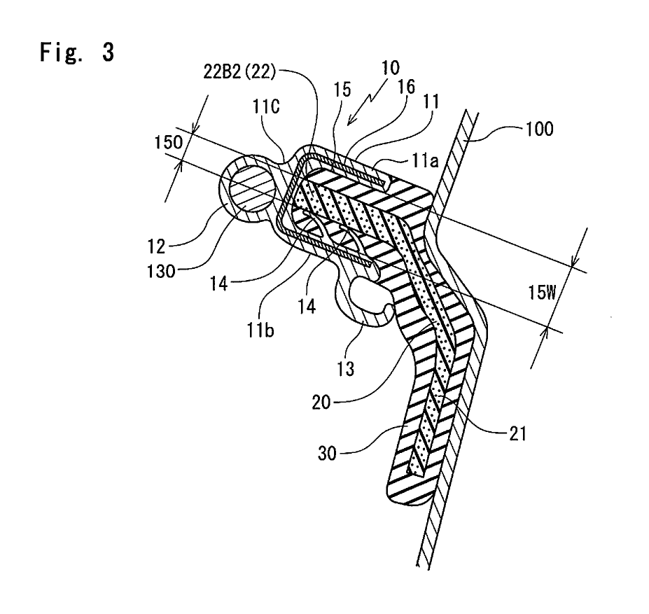

The concave 15 of the installation base member 11 on the end part of the weather strip 10 is uniform in cross sectional shape. The concave 15 is fit on the wide part 22A and the narrow part 22B of the convex 22 on the insert 20. That is, as shown in FIG. 2 and FIG. 3, more die molding material 30 flows into the concave 15 of the installation base member 11 with the narrow part 22B than the concave 15 of the installation base member 11 with the wide part 22A. As a result, fitting force of the concave 15 of the installation base member 11 is strong even at the narrow part 22B of the convex 22 on the insert 20.

Strength and weakness in the fitting force of the concave 15 of the installation base member 11 relative to the convex 22 on the insert 20 enables to operatively couple the installation base member 11 on the insert 20 more strongly. Also, positioning the installation base member 11 on the insert 20 for fitting becomes easy.

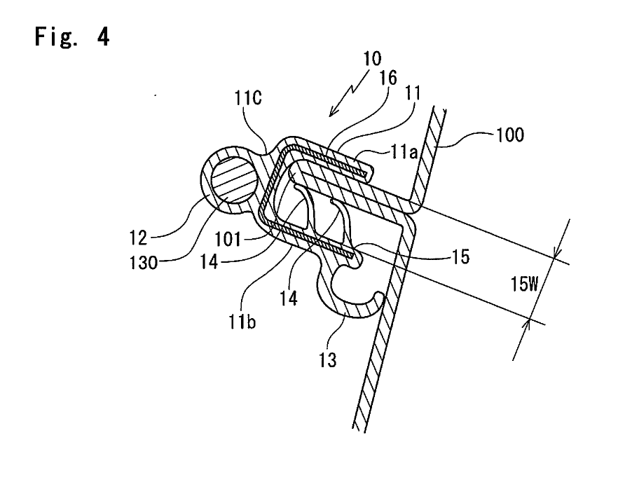

As shown in FIG. 4, except for the end part of the weather strip 10 formed by extrusion molding, which is a part of the weather strip 10 facing the flange 101 instead of the convex 22 on the insert 20, the concave 15 of the installation base member 11 is directly fit on the flange 101.

In addition, the end part of the insert 20 at a center side of the weather strip 10 is the wide part 22A1, and the corresponding concave 15 of the installation base member 11 of the weather strip 10 is fit on the wide part 22A1. The structure prevents the die molding material 30 for covering the insert 20 from flowing into a non-insert existing side of the concave 15 of the installation base member 11.

In accordance with the hole 23 formed on the insert 20, a hole 17 is formed on the weather strip 10 for fixing the weather strip 10 on the automobile body.

According to the present invention, the end part of the weather strip 10, which has the insert 20 buried therein and is formed by extrusion molding, is operatively coupled on the space 120 in which the flange 101 breaks off. The flange 101 is formed on the sliding door 100 of the automobile. The structure of the end part of the weather strip 10 is that: the concave 15 of the installation base member 11 of the weather strip 10 formed by extrusion molding is fit on the convex 22 on the insert 20; and the die molding material 30 integrally connects the concave 15 of the installation base member 11 and the convex 22 on the insert 20. Accordingly, the weather strip 10 is operatively coupled stably even on the position 110 without the flange 101.

Also, the end part of the weather strip 10, not a separate bracket as in the prior art, is directly installed on the position 110 without the flange 101. Accordingly, the end part of the weather strip 10 formed by extrusion molding may be extended from a position with the flange 101 and installed. As a result, the sensor 130 inserted in the hollow part 12 of the weather strip 10 detects objects over the wider range in an upward direction.

In the present embodiment, the two holding lips 14, 14 extend from the inner side of the second side wall 11b of the installation base member 11 and the concave 15 of the installation base member 11 is fit on the convex 22 on the insert 20 by pressing the concave 15 onto the convex 22. Alternatively, the holding lips (number not limited) may extend from the inner side of the first side wall 11a of the installation base member 11. As long as the concave 15 is pressed onto the convex 22, the holding lips on the installation base member 11 may be omitted and the width 140 of the wide part 22A may be substantially the same as or slightly wider than the width 15W of the concave 15 of the installation base member 11.

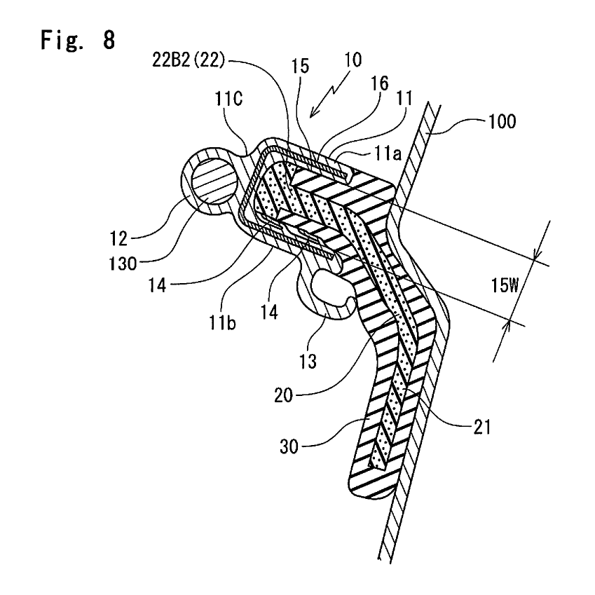

The insert 20 may vary in shape. Examples of variation include the insert 20 shown in FIG. 8 having a T-shaped cross section, of which top part of the narrow part 22B is wide in width. The insert 20 shown in FIG. 8 may be used in case the die molding material 30 which flows into the narrow part 22B of the insert 20 presses and deforms the connecting wall 11c of the installation base member 11 or the hollow part 12.

In the present embodiment, the structure of the end part of the weather strip 10 is for use on the sliding door 100, in which the hollow part 12 is integrally molded with the installation base member 11 and the sensor 130 is inserted in the hollow part 12 later. But the structure of the end part of the weather strip 10 is not necessarily for use on the sliding door 100 and is also applicable to side doors or back doors with a space in which the flange breaks off. In addition, the installation base member 11 having the U-shaped cross section is not necessarily integrally molded with the hollow part 12 for inserting the sensor 130 and may be integrally molded with the hollow part or a lip which is a sealing material for making elastic contact with the door opening side.

According to the structure, the end part of the weather strip 10 formed by extrusion molding may be extended from a position with the flange and installed. As a result, shape and sealing pressure of the hollow part or the lip of the weather strip 10 becomes substantially uniform.

Also, the invention is applicable to the space 120 on the body of the door opening side, not on the door, in which the flange 101 breaks off.

Further, the end part as a whole of the weather strip 10 may be formed by die molding and unified with the insert 20.

We claim:

1. A structure of an end part of a weather strip, the weather strip being operatively coupled on a space in which a flange breaks off, the flange being on a door of an automobile or on a body of a door opening side, the weather strip being formed by integrally molding a hollow part or a lip with an installation base member having a U-shaped cross section, the weather strip having an insert buried therein, wherein:
said insert has a convex formed thereon, the convex extending in a longitudinal direction of said weather strip, a concave of the installation base member on the end part of the weather strip being fit on said convex, and die molding material integrally connecting said end part of the weather strip and said insert.

2. The structure of the end part of the weather strip as claimed in claim 1, wherein: the convex formed on said insert comprises a wide part and a narrow part in plate thickness by turns in said longitudinal direction, and the concave of the installation base member of said weather strip is fit on the wide part and the narrow part of said convex.

3. The structure of the end part of the weather strip as claimed in claim 2, wherein: an end part of said insert at a center side of said weather strip is the wide part, and the concave of the installation base member of the weather strip is fit on the wide part.

4. The structure of the end part of the weather strip as claimed in claim 1, wherein: said hollow part is integrally molded with said installation base member, and the hollow part is a hollow for inserting a sensor therein, the sensor outputting an electric signal when an object is disposed between said door and the door opening for detecting the object.

5. The structure of the end part of the weather strip as claimed in claim 2, wherein: said hollow part is integrally molded with said installation base member, and the hollow part is a hollow for inserting a sensor therein, the sensor outputting an electric signal when an object is disposed between said door and the door opening for detecting the object.

6. The structure of the end part of the weather strip as claimed in claim 3, wherein: said hollow part is integrally molded with said installation base member, and the hollow part is a hollow for inserting a sensor therein, the sensor outputting an electric signal when an object is disposed between said door and the door opening for detecting the object.
